(19) United States
(12) Patent Application Publication
(10) Pub. No.: US 2001/0047833 A1
(43) Pub. Date: Dec. 6, 2001

(54) Gas flow structure in a compressor

(76) Inventors: Naofumi Kimura, Kariya-shi (JP); Masakazu Obayashi, Kariya-shi (JP)

Correspondence Address: Woodcock Washburn Kurtz Mackiewicz & Norris LLP, 46th Floor, One Liberty Place, Philadelphia, PA, 19103, US

(21) Appl. No.: 09/863,159

(22) Filed: May 23, 2001

(30) Foreign Application Priority Data
Jun. 1, 2000 (JP) 2000-164368

(51) Int. Cl. F16K 15/16

(52) U.S. Cl. 137/855

(57) ABSTRACT

The discharge port 27 comprises a tapered first diameter-increasing portion 28 and a tapered second diameter-increasing portion 29. The cross-sectional areas of the first diameter-increasing portion 28 and the second diameter-increasing portion 29 increase from the upstream toward the downstream of the discharge port 27. The rate of increase of the cross-sectional area of the second diameter-increasing portion 29 is designed so as to be greater than that of the first diameter-increasing portion 28. The second diameter-increasing portion 29 is connected to the first diameter-increasing portion 28 and the maximum cross-sectional area of the first diameter-increasing portion is equal to the minimum cross-sectional area of the second diameter-increasing portion.

### BACKGROUND OF THE INVENTION

1. Field of the Invention

The present invention relates to a gas flow structure, in a compressor, in which a gas flow port is opened/closed by an open/close valve.

2. Description of the Related Art

In a piston type compressor, the resistance to a gas flow when the gas is sucked from the suction chamber into the cylinder bore, or when discharged from the cylinder bore to the discharge chamber, has a considerable influence on volumetric efficiency. The more easily the gas flows, the greater the volumetric efficiency and the performance of a compressor improve.

The port disclosed in Japanese Unexamined Patent Publication (Kokai) No. 11-241683 comprises a diameter-increasing portion in which the diameter of the port gradually increases toward the exit end of the portion contiguous to the exit end of a port. The diameter-increasing portion contributes to the smooth flow of the gas at the port.

For the smooth flow of the gas at the port, it is very important to allow the gas to flow along the wall surface of the port without deviating from the wall surface of the diameter-increasing portion while diffusing appropriately. Though a single diameter-increasing portion has a form in which the diameter increases linearly or non-linearly, it is difficult to design an appropriate form of a single diameter-increasing portion contiguous to the exit end of a port so that the gas flows through the port without deviating from the wall surface of the diameter-increasing portion while diffusing appropriately. Unless an appropriate form of the single diameter-increasing portion is provided, it is impossible for the gas to flow without deviating from the wall surface of the diameter-increasing portion while diffusing appropriately.

### SUMMARY OF THE INVENTION

The objective of the present invention is to improve the smoothness of a gas flow at a flow port such as a suction port or a discharge port.

In order to achieve the above-mentioned objective, the gas flow port in the first aspect of the present invention is designed so as to comprise a first diameter-increasing portion and a second diameter-increasing portion, both having a cross-sectional area that increases from the upstream toward the downstream, wherein the first diameter-increasing portion is installed at the upstream of the second diameter-increasing portion and the rate of increase of the cross-sectional area at the second diameter-increasing portion is designed to be greater than that at the first diameter-increasing portion.

A situation in which the gas, which presses open the open/close valve that opens/closes the flow port and passes through the flow port, is diffusing appropriately just before the gas is about to exit from the flow port, has an advantage in a smooth flow through the flow port. The rate of diffusion of gas at the second diameter-increasing portion is greater than that at the first diameter-increasing portion. This relation between the two rates of diffusion of gas, that is, the relation between the rates of increase of the cross-sectional area at the first and the second diameter-increasing portions, is effective when the gas is controlled not to deviate from the wall surface of the flow port while appropriately diffusing and passing through the flow port.

The present invention will be more fully understood from the description of the preferred embodiments of the invention set forth below, together with the accompanying drawings.

### BRIEF DESCRIPTION OF THE DRAWINGS

In the drawings:

FIG. 1(a) is a side cross-sectional view of the entire compressor in the first embodiment.

FIG. 1(b) is a magnified side cross-sectional view of the major components in the first embodiment.

FIG. 2(a) is a section view along line A-A of FIG. 1(a).

FIG. 2(b) is a front elevation view with the major components magnified.

FIG. 3 is a magnified side cross-sectional view of the major components in the second embodiment.

FIG. 4 is a magnified side cross-sectional view of the major components in the third embodiment.

FIG. 5(a) is a magnified front elevation view of the major components in the fourth embodiment.

FIG. 5(b) is a section view along line B-B of FIG. 5(a).

FIG. 6(a) is a magnified front elevation view of the major components in the fifth embodiment.

FIG. 6(b) is a section view along line C-C of FIG. 6(a).

FIG. 6(c) is a section view along line D-D of FIG. 6(a).

FIG. 7(a) is a magnified front elevation view of the major components in the sixth embodiment.

FIG. 7(b) is a section view along line E-E of FIG. 7(a).

### DESCRIPTION OF THE PREFERRED EMBODIMENTS

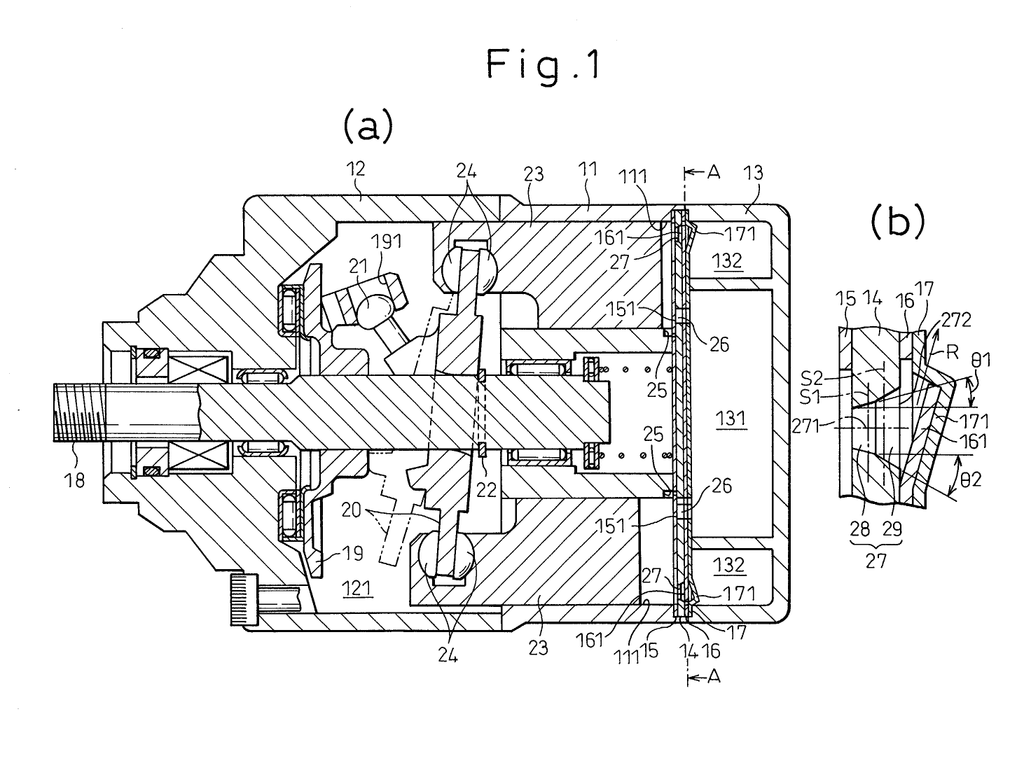

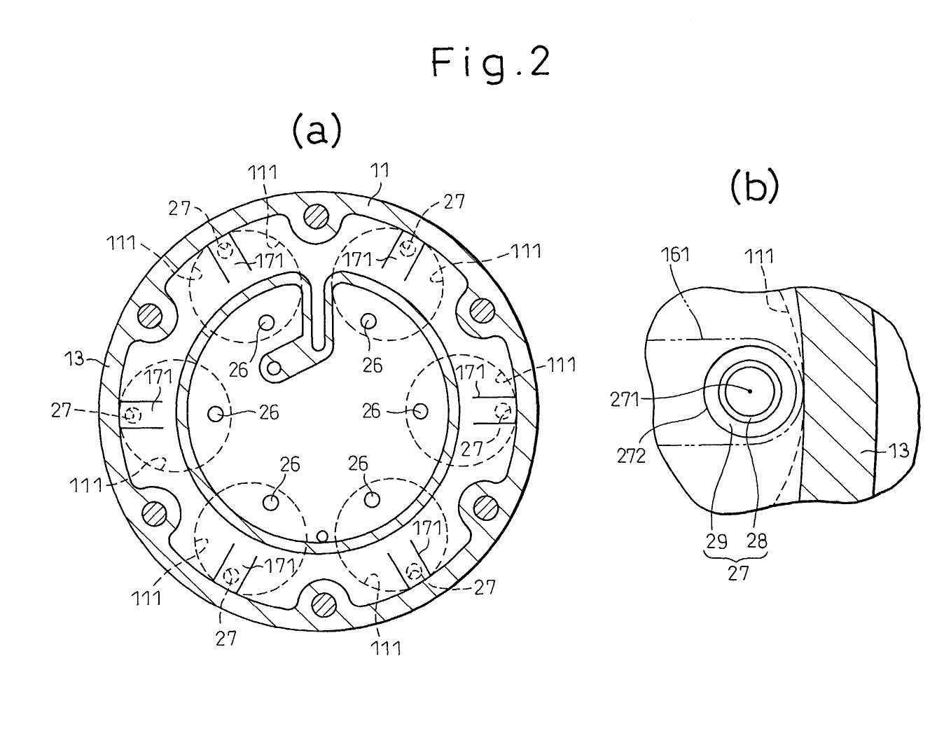

The present invention, realized in a variable displacement type compressor in the first embodiment, is described below with reference to FIGS. 1 and 2.

As shown in FIG. 1(a), a front housing 12 is coupled to the front end of a cylinder block 11. A rear housing 13 is fixed to the rear end of the cylinder block 11 via a defining plate 14, valve forming plates 15 and 16, and a retainer forming plate 17. A rotating shaft 18 is rotatably supported by the cylinder block 11 and the front housing 12, which form a control pressure chamber 121. The rotating shaft 18, which protrudes outward from the control pressure chamber 121, is driven by an external drive source such as a vehicle engine (not shown) via a pulley (not shown) and a belt (not shown).

A rotary support 19 is fixed to the rotating shaft 18. In addition, a swash plate 20 is supported by the rotating shaft 18 so that the swash plate 20 can slide and tilt in the direction of the axis of the rotating shaft 18. The swash plate 20 can tilt in the direction of the axis of the rotating shaft 18 and can rotate integrally with the rotating shaft 18 because a guide pin 21 that is fixed to the swash plate 20 collaborates with a guide hole 191 located on the rotary support 19. The inclination of the swash plate 20 is controlled by the slidably guiding contact between the guide hole 191 and the guide pin 21, and by the slidably supporting action of the rotating shaft 18.

When the radially central portion of the swash plate 20 moves toward the rotary support 19, the inclination of the swash plate 20 increases. When the radially central portion of the swash plate 20 moves toward the cylinder block 11, the inclination of the swash plate 20 decreases. The minimum inclination of the swash plate 20 is determined when the swash plate 20 comes into contact with a circlip 22 attached to the rotating shaft 18. The maximum inclination of the swash plate 20 is determined when the swash plate 20 comes into contact with the rotary support 19. The position of the swash plate 20 as shown by a solid line in FIG. 1(a) indicates the inclination of the swash plate 20 at the minimum inclination, and that shown by a dotted line indicates the inclination of the swash plate 20 at the maximum inclination. As the pressure inside the control pressure chamber 121 becomes higher, the inclination of the swash plate 20 decreases. As the pressure inside the control pressure chamber 121 becomes lower, the inclination of the swash plate 20 increases. The inclination of the swash plate 20 can be controlled by adjusting the pressure inside the control pressure chamber 121.

As shown in FIG. 2(a), plural (six in this embodiment) cylinder bores 111 penetrate through the cylinder block 11. The plural cylinder bores 111 are equally spaced around the rotating shaft 18. As shown in FIG. 1(a), a piston 23 is housed in each cylinder bore 111. The rotational motion of the swash plate 20 is converted into the reciprocating motion of the piston 23 via a shoe 24, and the piston 23 reciprocates in the cylinder bore 111.

A suction port 26 is formed in the defining plate 14, the valve forming plate 16, and the retainer forming plate 17, corresponding to each cylinder bore 111. A discharge port 27, which is a flow port, is formed in the defining plate 14, corresponding to each cylinder bore 111. A suction valve 151 is formed on the valve forming plate 15 and a discharge valve 161, which is an open/close valve, is formed on the valve forming plate 16. The maximum opening of the suction valve 151 is determined by a maximum opening-degree determining recess 25.

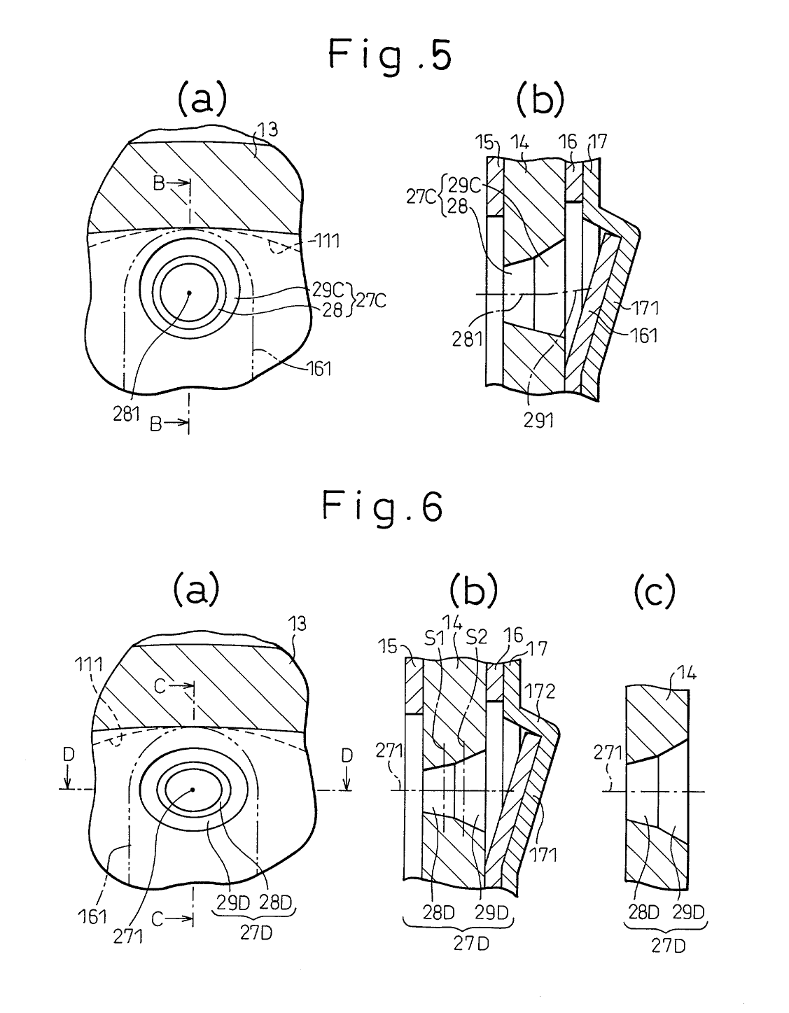

A suction chamber 131 and a discharge chamber 132 are defined in the rear housing 13. The refrigerant gas in the suction chamber 131 presses open the suction valve 151 from the suction port 26 and is sucked into the cylinder bore 111 by the reciprocating motion (movement from right to left in FIG. 1(a)) of the piston 23. The refrigerant gas in the cylinder bore 111 presses open the discharge valve 161 from the discharge port 27 and is discharged to the discharge chamber 132 by the reciprocating motion (movement from left to right in FIG. 5(a)) of the piston 23. The opening-degree of the discharge valve 161 is determined when the discharge valve 161 comes into contact with a retainer 171 on the retainer forming plate 17. The refrigerant gas discharged to the discharge chamber 132 is fed back to the suction chamber 131 via an external refrigerant circuit (not shown) outside the compressor.

As shown in FIG. 1(b), the discharge port 27 comprises a tapered first diameter-increasing portion 28 and a tapered second diameter-increasing portion 29. The second diameter-increasing portion 29 is placed at the downstream of the first diameter-increasing portion 28, and is connected to the first diameter-increasing portion 28. The cross-sectional area of the first diameter-increasing portion 28 is the area of the cross-sectional circle of the first diameter-increasing portion 28 on a plane (for example, S1 in FIG. 1(b)) that is perpendicular to an axial line 271 of the discharge port 27. The cross-sectional area of the second diameter-increasing portion 29 is the area of the cross-sectional circle of the second diameter-increasing portion 29 on the plane (for example, S2 in FIG. 1(b)) that is perpendicular to the axial line 271 of the discharge port 27. The axial line 271 connects the center of area of the cross-sectional shape of the first diameter-increasing portion 28 on the plane S1 and the center of area of the cross-sectional shape of the second diameter-increasing portion 29 on the plane S2. Therefore, the center of the circle of the first diameter-increasing portion 28 on the plane S1 is located on the axial line 271 and the center of the circle of the second diameter-increasing portion 29 on the plane S2 is located on the axial line 271.

The cross-sectional areas of the first and the second diameter-increasing portions 28 and 29 increase from the upstream of the discharge port 27 (near the cylinder bore 111) toward the downstream (near the discharge chamber 132). The inclination θ2 of the wall surface of the second diameter-increasing portion 29 with respect to the axial line 271 of the discharge port 27 is designed so as to be greater than the inclination θ1 of the wall surface of the first diameter-increasing portion 28 with respect to the axial line 271 of the discharge port 27. In other words, the rate of increase of the cross-sectional area of the second diameter-increasing portion 29 is designed to be greater than that of first diameter-increasing portion 28. Because the second diameter-increasing portion 29 is connected to the first diameter-increasing portion 28, the maximum cross-sectional area of the first diameter-increasing portion 28 is equal to the minimum cross-sectional area of the second diameter-increasing area 29.

The following effects can be obtained in the first embodiment.

(1-1)

The refrigerant gas that presses open the discharge valve 161, which opens/closes the discharge port 27, and passes through the discharge port 27, flows out into the discharge chamber 132 through the top end of the discharge valve 161 in a direction oblique to the side as shown by the arrow R in FIG. 1(b). If the direction, in which the refrigerant gas discharged from the discharge port 27 along the vicinity of an opening margin 272 at the exit side of the discharge port 27 flows, is tilted with respect to the axial line 271 of the discharge port 27 just before the gas is about to exit from the discharge port 27, the direction of the flow of the refrigerant gas discharged from the discharge port 27 changes smoothly to the direction of the arrow R. Such a smooth change in direction of the flow of the refrigerant gas considerably affects the smooth flow of the refrigerant gas at the discharge port 27. Therefore, it is preferable that the direction in which the refrigerant gas discharged from the discharge port 27, in the vicinity of the opening margin 272, flows, is tilted with respect to the axial line 271 of the discharge port 27 just before the gas is about to exit from the discharge port 27.

It is also preferable that the inclination θ2 of the second diameter-increasing portion 29 is large to a certain extent in order to enable a smooth transition in direction from the direction in which the refrigerant gas discharged from the discharge port 27, in the vicinity of the opening margin 272, flows, to the direction of the arrow R. If, however, the inclination of the wall surface of the discharge port 27 is too large at first, the flow of refrigerant gas along the wall surface of the discharge port 27 is apt to deviate from the wall surface of the discharge port 27. A situation in which the flow of refrigerant gas along the wall surface of the discharge port 27 deviates from the wall surface of the discharge port 27 adversely affects the smooth flow of refrigerant gas within the discharge port 27.

The inclination θ1 of the first diameter-increasing portion 28 is designed so as to be smaller than the inclination θ2 of the second diameter-increasing portion 29, and the diffusion rate of refrigerant gas at the first diameter-increasing portion 28 is smaller than that at the second diameter-increasing portion 29. Such design of the first diameter-increasing portion 28 thus contributes to preventing the flow of refrigerant gas from deviating from the wall surface of the discharge port 27. Therefore, a structure in which the diffusion rate of refrigerant gas at the second diameter-increasing portion 29 is greater than that at the first diameter-increasing portion 28, that is, the rate of increase of the cross-sectional area of the second diameter-portion 29 is greater than that of the first diameter-increasing portion 28, has an advantage in preventing the refrigerant gas from deviating from the wall surface of the discharge port 27 and enabling a smooth flow of the refrigerant gas through the discharge port 27 with an appropriate diffusion.

In such a structure, the dead volume can be reduced compared to other structures in which a diameter-increasing portion having a single inclination θ2 is formed, resulting in an improved performance of a compressor.

(1-2)

Both the first diameter-increasing portion 28 and the second diameter-increasing portion 29 have a tapered shape. The tapered shape has an advantage in easily forming the diameter-increasing portions 28 and 29 with high precision.

(1-3)

Because the second diameter-increasing portion 29 is connected to the first diameter-increasing portion 28, the diffusion of the refrigerant gas within the discharge port 27 is kept continuous when the refrigerant gas flows from the first diameter-increasing portion 28 to the second diameter-increasing portion 29. Such continuity of diffusion contributes to the smooth flow of the refrigerant gas within the discharge port 27.

(1-4)

The whole area of the discharge port 27 is occupied with the first diameter-increasing portion 28 and the second diameter-increasing portion 29. Therefore, the refrigerant gas that flows through the discharge port 27 always diffuses when flowing from the upstream to the downstream. This contributes to the smooth flow of the refrigerant gas within the discharge port 27.

The longer the lengths of the first diameter-increasing portion 28 and the second diameter-increasing portion 29 are, the better they are in preventing the flow of the refrigerant gas from deviating from the wall surface of the discharge port 27 and enabling the smooth flow through the discharge port 27 with an appropriate diffusion. If, however, the length of the first diameter-increasing portion 28 and the second diameter-increasing portion 29 is made longer, it is necessary to increase the thickness of the defining plate 14, resulting in an increase in weight and volume of the compressor. Therefore, the structure described above, in which the whole area of the discharge port 27 is occupied with the first diameter-increasing portion 28 and the second diameter-increasing portion 29 has an advantage in preventing an increase in the thickness of the defining plate 14.

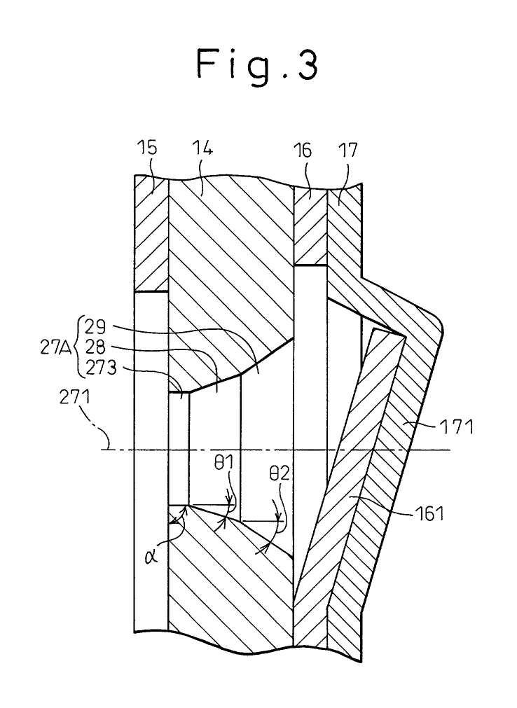

Next the second embodiment shown in FIG. 3 is described. The same reference numbers are assigned to the same components as in the first embodiment.

A discharge port 27A has a constant-diameter portion 273 at the entrance side. The wall surface of the constant-diameter portion 273 is parallel to the axial line 271 and the angle a of the edge portion at the entrance side of the discharge port 27A is 90 degrees. The constant-diameter portion 273 contributes to preventing the flow of the refrigerant gas from deviating from the wall surface of the discharge port 27A.

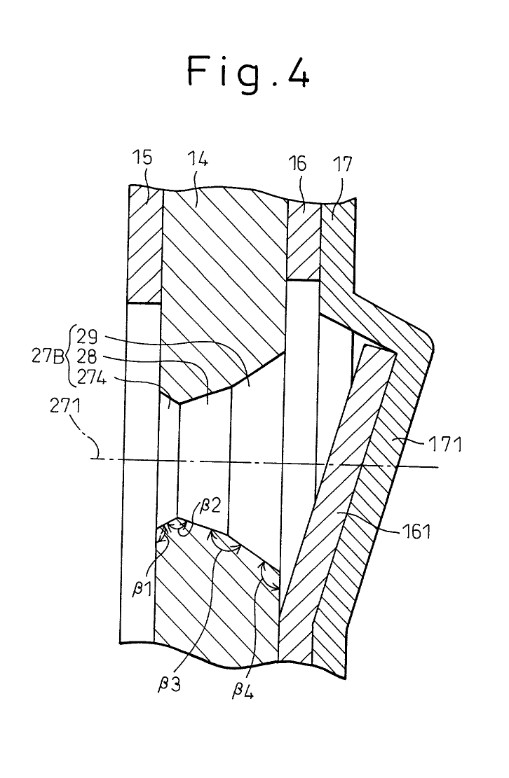

Next the third embodiment shown in FIG. 4 is described. The same reference numbers are assigned to the same components as in the first embodiment.

A discharge port 27B has a diameter-decreasing portion 274 at the entrance side. The cross-sectional area of the diameter-decreasing portion 274 decreases from the upstream toward the downstream. Each angle β1, β2, β3, and β4 of each edge portion at the discharge port 27B is obtuse. Such obtuse shape has an advantage in reducing a resistance to the gas flow at the discharge port 27B.

Next the fourth embodiment shown in FIG. 5(a) and FIG. 5(b) is described. The same reference numbers are assigned to the same components as in the first embodiment.

Though an axial line 281 of the first diameter-increasing portion 28 of a discharge port 27C coincides with the axial line 271 of the discharge port 27 in the first embodiment, an axial line 291 of the second diameter-increasing portion 29C tilts with respect to the axial line 281. The cross-sectional area of the second diameter-increasing area 29C is the area of the cross-sectional circle of the second diameter-increasing portion 29C on the plane S2 that is perpendicular to the axial line 281, and the center of the circle of the second diameter-increasing portion 29C is located on the axial line 291. The axial line 291 tilts in the direction from the proximal end to the top end of the discharge valve 161.

In the valve-opened state, the discharge valve 161 deviates from the defining plate 14 more toward the top end, and the refrigerant gas is apt to flow out from the top end of the discharge valve 161. Therefore, the more the quantity of the refrigerant gas that flows toward the top end of the discharge valve 161, the smoother the refrigerant gas at the discharge port flows. The inclination of the wall surface of the second diameter-increasing portion 29C with respect to the axial line 281 increases toward the top end of the discharge valve 161. Therefore, the quantity of the refrigerant gas that flows through the second diameter-increasing portion 29C toward the top end of the discharge valve 161 is larger than that in the first embodiment, and the ease with which the gas flows at the discharge port 27C is further improved than that in the first embodiment.

Next the fifth embodiment in FIG. 6(a), FIG. 6(b), and FIG. 6(c) is described. The same reference numbers are assigned to the same components as in the first embodiment.

Both the cross-sectional shape of the first diameter-increasing portion 28D on the plane S1 and the cross-sectional shape of the second diameter-increasing portion 29D on the plane S2 of the discharge port 27D are ellipses. The minor axis of the ellipse is parallel to the longitudinal direction of the discharge valve 161 and the major axis of the ellipse is perpendicular to the longitudinal direction of the discharge valve 161. Therefore, the quantity of the refrigerant gas that flows through the second diameter-increasing portion 29D toward both the left and the right sides of the discharge valve 161 is larger than that in the first embodiment. There exists a part 172 of the retainer 171 on the extended line of the top end of the discharge valve 161, acting as a blocking partition, blocking the refrigerant gas flowing out from the discharge port. Therefore, it is preferable that the refrigerant gas flowing out from the discharge port is directed to the left and the right sides of the discharge valve 161. In the structure in which the quantity of the refrigerant gas that flows though the second diameter-increasing portion 29D toward the left and the right sides of the discharge valve 161 is increased compared to that in the first embodiment, the ease with which the gas flows at the discharge port 27D is further improved than that in the first embodiment.

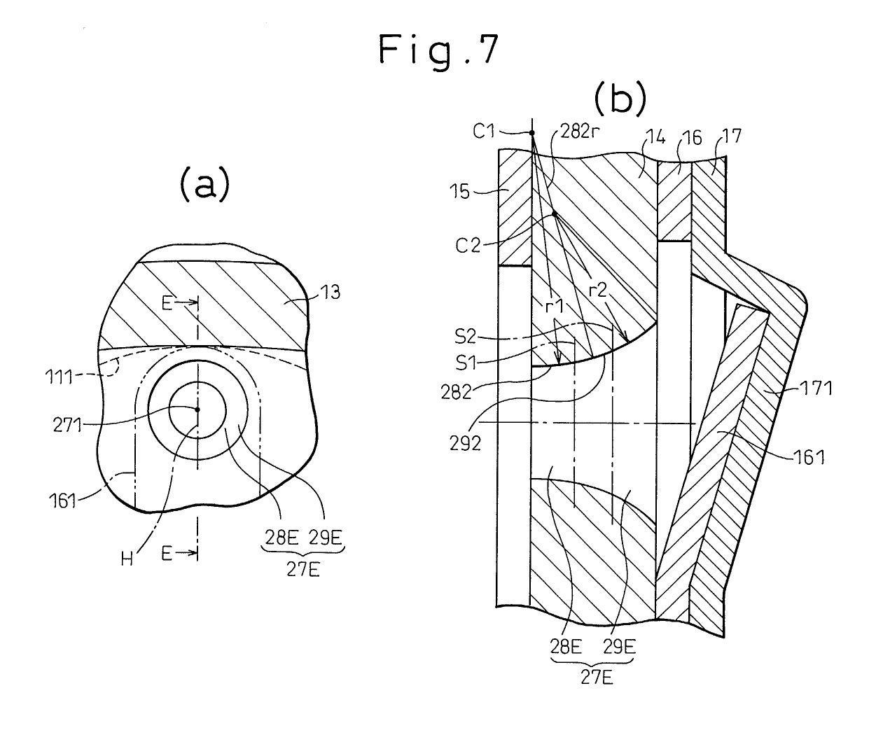

Next the sixth embodiment in FIGS. 7(a) and (b) is described. The same reference numbers are assigned to the same components as in the first embodiment.

Both the cross-sectional shape of the first diameter-increasing portion 28E on the plane S1 and the cross-sectional shape of the second diameter-increasing portion 29E on the plane S2 of the discharge port 27E are circles. The shape of a line of the wall surface of the first diameter-increasing portion 28E on a plane H including the axial line 271 is an arc 282. The shape of a line of the wall surface of the second diameter-increasing portion 29E on the plane H is an arc 292. The length r1 of the radius of the arc 282 is designed to be longer than the length r2 of the radius of a circle that includes the arc 292. The center C1 of the circle that includes the arc 282 is located on the wall surface of one side of the defining plate 14 and the center C2 of the circle that includes the arc 292 is located on the marginal radius 282r of a circle that includes the arc 282. The rate of increase of cross-sectional area of the second diameter-increasing portion 29E is greater than that of the first diameter-increasing portion 28E.

The same effects are obtained in the sixth embodiment similarly as that described in items (1-1), (1-3), and (1-4) in the first embodiment.

The present invention may include the following modifications of the embodiments.

(1) The cross-sectional shape of the first diameter-increasing portion is made different from that of the second diameter-increasing portion. For example, the cross-sectional shape of the first diameter-increasing portion is a circle and that of the second diameter-increasing portion is an ellipse.

(2) Instead of an arc, other curves are used in the sixth embodiment.

(3) The present invention is applied to a suction port.

As described above, in the present invention, an excellent effect that the smoothness with which gas flows at a flow port such as a suction port or a discharge port can be improved because: the flow port comprises the first diameter-increasing portion and the second diameter-increasing portion, the cross-sectional areas of which increase from the upstream toward the downstream; the first diameter-increasing portion is placed at the upstream of the second diameter-increasing portion; and the rate of increase of cross-sectional area of the second diameter-increasing portion is designed so as to be greater than that of the first diameter-increasing portion.

While the invention has been described by reference to specific embodiments chosen for the purposes of illustration, it should be apparent that numerous modifications could be made thereto by those skilled in the art without departing from the basic concept and scope of the invention.

1. A gas flow structure in a compressor in which a flow port for gas is opened/closed by an open/close valve, wherein:
the flow port comprises the first diameter-increasing portion and the second diameter-increasing portion, with the cross-sectional areas of which increasing from the upstream toward the downstream;
the first diameter-increasing portion is placed at the upstream of the second diameter-increasing portion; and
the rate of increase of the cross-sectional area of the second diameter-increasing portion is designed so as to be greater than that of the first diameter-increasing portion.

2. A gas flow structure in a compressor, as set forth in claim 1, wherein the first diameter-increasing portion and the second diameter-increasing portion have a tapered shape.

3. A gas flow structure in a compressor, as set forth in claim 1, wherein the second diameter-increasing portion is connected to the first diameter-increasing portion.

4. A gas flow structure in a compressor, as set forth in claim 1, wherein the whole area of the flow port is occupied by the first diameter-increasing portion and the second diameter-increasing portion.

5. A gas flow structure in a compressor, as set forth in claim 1, wherein a diameter-decreasing portion is installed at the entrance side of the flow port.

6. A gas flow structure in a compressor, as set forth in claim 1, wherein the minimum cross-sectional area of the second diameter-increasing portion is equal to the maximum cross-sectional area of the first diameter-increasing portion.
